(19) United States
(12) Patent Application Publication
(10) Pub. No.: US 2026/0188710 A1
(43) Pub. Date: Jul. 2, 2026

(54) COOLING DEVICE AND FUEL CELL SYSTEM

(71) Applicant: HONDA MOTOR CO., LTD., TOKYO (JP)

(72) Inventor: Kenta SUGITATE, WAKO-SHI (JP)

(21) Appl. No.: 19/427,450

(22) Filed: Dec. 19, 2025

(30) Foreign Application Priority Data
Dec. 26, 2024 (JP) 2024-230210

(51) Int. Cl. H01M 8/04029; H01M 8/04007

(52) U.S. Cl. CPC H01M 8/04029; H01M 8/04067

(57) ABSTRACT

A cooling device mounted on a fuel cell system discharges exhaust air from a plurality of radiators through a first central exhaust duct and a second central exhaust duct. Exhaust air from a part of the radiators is introduced into the first central exhaust duct so as to rotate in a first rotation direction, and exhaust air from another part of the radiators is introduced into the second central exhaust duct so as to rotate in a second rotation direction opposite to the first rotation direction.

### CROSS-REFERENCE TO RELATED APPLICATIONS

This application is based upon and claims the benefit of priority from Japanese Patent Application No. 2024-230210 filed on Dec. 26, 2024, the contents of which are incorporated herein by reference.

### BACKGROUND OF THE INVENTION

### Field of the Invention

The present disclosure relates to a cooling device and a fuel cell system.

### Description of the Related Art

Various systems have been proposed in which devices such as a storage battery, a power generation device, or an electronic computer are mounted in a container or the like and can be transported to and installed at a place requiring those devices. In such a system, a large number of devices that generate heat are mounted in a sealed space such as a container, and thus it is necessary to perform appropriate cooling.

For example, U.S. Pat. No. 11,862,831 B2 discloses a cooling device for a container in which a plurality of fuel cells are mounted.

### SUMMARY OF THE INVENTION

As an example of a cooling device, a liquid-cooling device is known that cools a heat generating device by circulating a coolant such as water between the heat generating device and radiators. This cooling device takes in outside air using a blower fan in order to cool the plurality of radiators. The outside air taken in becomes warm exhaust air as a result of heat exchange with the radiators, and is discharged to the outside of the container through an exhaust duct provided in the cooling device.

In the case where a plurality of containers are arranged, if warm exhaust air is blown to an adjacent container, cooling of other containers may be affected. Thus, it is preferable that the exhaust duct collects exhaust air from the plurality of radiators and ejects the collected exhaust air upward with great force.

However, depending on the layout of the plurality of connection ducts connecting the radiators and the exhaust duct, the exhaust air may flow while rotating in a predetermined direction inside the exhaust duct. When such a rotating flow is generated, the exhaust duct receives a reaction force of the exhaust air, and receives a rotational moment in a direction opposite to the rotation direction of the exhaust air.

Therefore, the frame supporting the exhaust duct is required to have rigidity capable of bearing the rotational moment acting on the exhaust duct, and thus there is a problem that the frame must be increased in size.

It is an object of the present disclosure to solve the above problems.

A first aspect of the present disclosure is a cooling device including: a first central exhaust duct; a second central exhaust duct disposed adjacent to and parallel to the first central exhaust duct; a plurality of first radiators disposed near the first central exhaust duct; a plurality of first connection ducts configured to guide exhaust air from the plurality of first radiators to the first central exhaust duct; a plurality of second radiators disposed near the second central exhaust duct; a plurality of second connection ducts configured to guide exhaust air from the plurality of second radiators to the second central exhaust duct; and a frame that supports the first central exhaust duct and the second central exhaust duct, wherein the plurality of first connection ducts are connected to the first central exhaust duct in an orientation in which the exhaust air generates a flow in a first rotation direction inside the first central exhaust duct, and the plurality of second connection ducts are connected to the second central exhaust duct in an orientation in which the exhaust air generates a flow in a second rotation direction that is opposite to the first rotation direction, inside the second central exhaust duct.

A second aspect of the present disclosure is a fuel cell system including the cooling device according to the first aspect and a plurality of fuel cells, wherein the number of the fuel cells is the same as the total number of the first radiators and the second radiators, and the plurality of fuel cells are connected in parallel to the cooling device.

According to the present disclosure, the rotational moment generated in the first exhaust duct and the rotational moment generated in the second exhaust duct are opposite in direction, and thus the rotational moments cancel each other out. Accordingly, the frame holding the exhaust ducts does not receive the rotational moment, and thus the size of the frame can be reduced.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a perspective view of a fuel cell system according to a first embodiment of the present disclosure;

FIG. 2 is an enlarged side view of the cooling device of FIG. 1;

FIG. 3 is a cross-sectional view of the cooling device taken along line III-III in FIG. 2;

FIG. 4 is a cross-sectional view of a cooling device according to a comparative example; and

FIG. 5 is a cross-sectional view of a cooling device according to a second embodiment of the present disclosure.

### DETAILED DESCRIPTION OF THE INVENTION

### First Embodiment

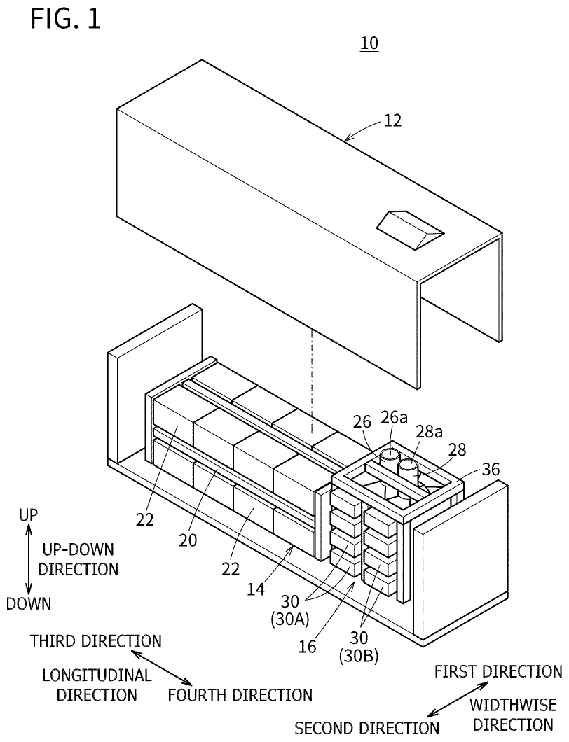

As shown in FIG. 1, a fuel cell system 10 of the present embodiment is housed in a standardized container 12 (also referred to as a dry container or a general-purpose container). The fuel cell system 10 is assembled in a factory and then transported to a predetermined installation site by various transportation means such as a ship, a railroad, and a truck. The fuel cell system 10 of the present embodiment generates electric power at the installation site and supplies electric power to a consuming facility. The fuel cell system 10 is used as, for example, a backup power supply facility in a data center, a private power generation facility in a factory, a building, a public facility, or the like.

The fuel cell system 10 includes a fuel cell section 14 and a cooling device 16. The fuel cell section 14 is provided with a mounting rack 20 divided into a plurality of subsections. The fuel cell 22 is housed in each subsection of the mounting rack 20. The fuel cell section 14 may include a predetermined number of fuel cells 22, such as two, four, eight, sixteen, or thirty two, depending on the size of the container 12 and the power demand. In the illustrated example, the fuel cell section 14 contains sixteen fuel cells 22. Further, the container 12 may include a high-voltage unit that converts electric power output from the plurality of fuel cells 22 into direct-current (DC) or alternating-current (AC) electric power of a predetermined voltage and outputs the DC or AC electric power to the outside, as necessary.

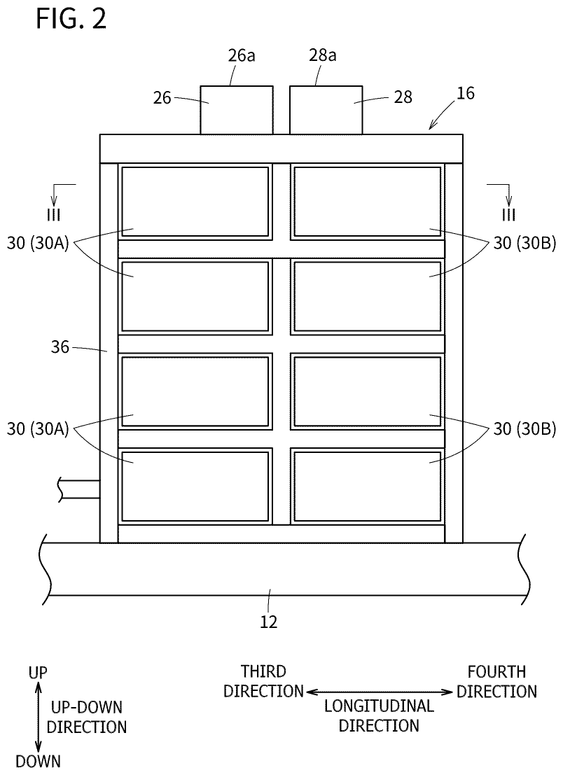

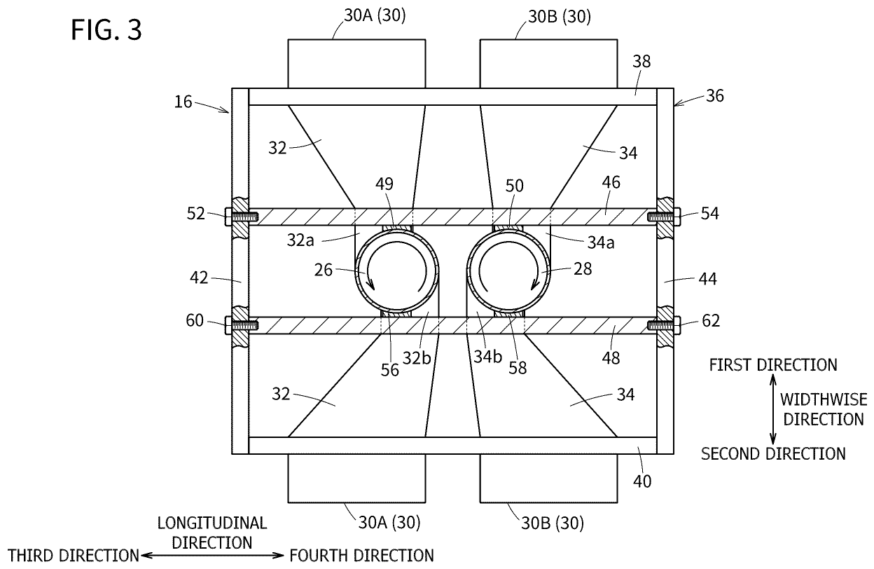

The cooling device 16 will be described below with reference to FIGS. 2 and 3. The cooling device 16 includes a first central exhaust duct 26, a second central exhaust duct 28, a plurality of radiators 30 (a first radiator 30A and a second radiator 30B), a first connection duct 32, a second connection duct 34, and a frame 36.

In the following description, terms such as a widthwise direction, a longitudinal direction, and an up-down direction are used to represent a relative positional relationship of portions of the cooling device 16. The widthwise direction is a direction in which outside air of the radiator 30 is taken in and exhaust air is discharged, and one direction of the widthwise direction is referred to as a first direction and the opposite direction is referred to as a second direction. The longitudinal direction is a direction in which the first central exhaust duct 26 and the second central exhaust duct 28 are arranged. One direction of the longitudinal direction is referred to as a third direction, and the opposite direction is referred to as a fourth direction. The up-down direction is a direction in which the central axes of the first central exhaust duct 26 and the second central exhaust duct 28 extend. The up-down direction is orthogonal to the widthwise direction and the longitudinal direction. The terms “widthwise direction”, “longitudinal direction”, and “up-down direction” are unrelated to the shape of the container 12, and the orientation in which the cooling device 16 is disposed is not restricted by the shape of the container 12.

The first central exhaust duct 26 is located near the center in the widthwise direction. The first central exhaust duct 26 has a circular cross section and extends linearly in the up-down direction. The lower end of the first central exhaust duct 26 is sealed, and the upper end thereof serves as a first exhaust port 26a. The first central exhaust duct 26 discharges exhaust air to the upper side of the container 12 through the first exhaust port 26a.

The second central exhaust duct 28 is disposed adjacent to the first central exhaust duct 26 in the fourth direction. The second central exhaust duct 28 is located on a side of the fourth direction with respect to the first central exhaust duct 26, and extends linearly upward in parallel to the first central exhaust duct 26. The second central exhaust duct 28 has a second exhaust port 28a at an upper portion thereof. The exhaust air from the second central exhaust duct 28 is discharged upward of the container 12 through the second exhaust port 28a.

The number of the radiators 30 is the same as the number of the fuel cells 22 mounted in the fuel cell section 14. One radiator 30 is assigned to each fuel cell 22. The fuel cell 22 and the radiator 30 are connected by a coolant pipe. Cooling water circulates between the fuel cell 22 and the radiator 30 through the coolant pipe. That is, the plurality of fuel cells 22 are connected in parallel to the plurality of radiators 30. Such a combination of the fuel cells 22 and the radiators 30 enables the fuel cells 22 and the radiators 30 for fuel cell vehicles, which are mass-produced in large quantities, to be diverted, and enables the unit cost to be reduced.

The radiator 30 has a built-in fan unit (not shown), and takes in outside air from a side portion in the short-side direction of the container 12. The outside air taken in exchanges heat with the cooling water in the radiator 30 and is discharged from the radiator 30 as high-temperature exhaust air.

In the cooling device 16, a plurality of radiators 30 are arranged on a side of the first direction of the container 12 and on a side of the second direction thereof. In the example shown in FIG. 2, eight radiators 30 are arranged on the side of the first direction. Two radiators 30 are arranged in the longitudinal direction of the container 12 (i.e., forming two rows), and four radiators 30 are stacked in the up-down direction. Further, also on a side of the second direction of the container 12, eight radiators 30 are also arranged in two rows in the longitudinal direction and in four tiers in the up-down direction.

As shown in FIG. 3, in one of the four tiers, a subset of the radiators 30 are connected to the first central exhaust duct 26, and the other subset of the radiators 30 are connected to the second central exhaust duct 28. In the following description, the radiators 30 connected to the first central exhaust duct 26 are referred to as first radiators 30A. The radiators 30 connected to the second central exhaust duct 28 are referred to as second radiators 30B. The first radiator 30A is provided in a pair so as to sandwich the first central exhaust duct 26 in the widthwise direction. The second radiator 30B is provided in a pair so as to sandwich the second central exhaust duct 28 in the widthwise direction.

The first radiators 30A are connected to the first central exhaust duct 26 through respective first connection ducts 32. Each of the first connection ducts 32 extends in the widthwise direction and is connected to a side portion of the first central exhaust duct 26. The number of the first connection ducts 32 is the same as the number of the first radiators 30A. In the present embodiment, the cooling device 16 includes a pair of the first connection ducts 32. One of the first connection ducts 32 extends in the first direction from the first central exhaust duct 26, and the other first connection duct 32 extends in the second direction from the first central exhaust duct 26. Each of the first connection ducts 32 is narrowed such that the cross-sectional area of the first connection duct 32 decreases as it approaches the first central exhaust duct 26.

The first connection duct 32 extending in the first direction from the first central exhaust duct 26 has a first downstream end 32a extending in the widthwise direction in the vicinity of the first central exhaust duct 26. The first downstream end 32a ejects the exhaust air into the first central exhaust duct 26 in the second direction. The first connection duct 32 extending in the second direction from the first central exhaust duct 26 has a second downstream end 32b extending in the widthwise direction in the vicinity of the first central exhaust duct 26. The second downstream end 32b ejects the exhaust air into the first central exhaust duct 26 in the first direction.

In the present embodiment, the first downstream end 32a and the second downstream end 32b are arranged to be shifted from each other in the longitudinal direction perpendicular to the widthwise direction. With this configuration, the collision of the exhaust air ejected from the first downstream end 32a and the exhaust air ejected from the second downstream end 32b is avoided, the resistance to exhaust gas flow is suppressed, and the decrease in the exhaust gas flow rate is prevented. As shown, the first downstream end 32a is shifted (offset) in the third direction relative to the second downstream end 32b. Therefore, the exhaust air inside the first central exhaust duct 26 generates a rotating flow in a first rotation direction that is counterclockwise when viewed from above.

The second radiators 30B are connected to the second central exhaust duct 28 through respective second connection ducts 34. Each of the second connection ducts 34 extends in the widthwise direction and is connected to a side portion of the second central exhaust duct 28. The cooling device 16 of the present embodiment includes a pair of the second connection ducts 34. One of the second connection ducts 34 extends in the first direction from the second central exhaust duct 28, and the other second connection duct 34 extends in the second direction from the second central exhaust duct 28. Each of the second connection ducts 34 is narrowed such that the cross-sectional area of the second connection duct 34 decreases as it approaches the second central exhaust duct 28.

The second connection duct 34 extending in the first direction from the second central exhaust duct 28 has a third downstream end 34a extending in the widthwise direction in the vicinity of the second central exhaust duct 28. The third downstream end 34a ejects the exhaust air into the second central exhaust duct 28 in the second direction. The second connection duct 34 extending in the second direction from the second central exhaust duct 28 has a fourth downstream end 34b extending in the widthwise direction in the vicinity of the second central exhaust duct 28. The fourth downstream end 34b ejects the exhaust air into the second central exhaust duct 28 in the first direction.

In the present embodiment, the third downstream end 34a and the fourth downstream end 34b are disposed so as to be shifted in the longitudinal direction. With this configuration, the collision of the exhaust air ejected from the third downstream end 34a and the exhaust air ejected from the fourth downstream end 34b is avoided, the resistance to exhaust gas flow is suppressed, and the decrease in the exhaust gas flow rate is prevented. As shown, the third downstream end 34a is shifted (offset) in the fourth direction relative to the fourth downstream end 34b. Therefore, the exhaust air inside the second central exhaust duct 28 generates a rotating flow in a second rotation direction that is clockwise when viewed from above.

In the above description, the shapes and the arrangement relationship of the first radiators 30A, the second radiators 30B, the first connection ducts 32, and the second connection ducts 34 belonging to one tier of the four tiers have been described, but these components belonging to the other tiers also have the same arrangement relationship. That is, the first radiators 30A, the second radiators 30B, the first connection ducts 32, and the second connection ducts 34 have the same arrangement relationship as shown in FIG. 3 in each tier of the plurality of tiers, and are stacked in the up-down direction.

The frame 36 includes a first frame body 38, a second frame body 40, a first coupling portion 42, a second coupling portion 44, a first duct support portion 46, and a second duct support portion 48. The first frame body 38 is positioned near an end portion of the cooling device 16 in the first direction. The first frame body 38 extends in the longitudinal direction and supports the plurality of radiators 30 located on a side of the first direction. The second frame body 40 is positioned near an end portion of the cooling device 16 in the second direction. The second frame body 40 extends in the longitudinal direction and supports the plurality of radiators 30 located on a side of the second direction. The first coupling portion 42 is located near an end portion in the third direction and extends in the widthwise direction. The first coupling portion 42 couples the first frame body 38 and the second frame body 40 at the end portion in the third direction. The second coupling portion 44 is located near an end portion in the fourth direction and extends in the widthwise direction. The second coupling portion 44 couples the first frame body 38 and the second frame body 40 at the end portion in the fourth direction.

The first duct support portion 46 extends in the longitudinal direction and abuts on the first central exhaust duct 26 and the second central exhaust duct 28 from the first direction. The first duct support portion 46 is joined to the first central exhaust duct 26 at a first joint portion 49, and is joined to the second central exhaust duct 28 at a second joint portion 50. Further, the vicinity of an end portion of the first duct support portion 46 in the third direction is joined to the first coupling portion 42 at a third joint portion 52. The vicinity of an end portion of the first duct support portion 46 in the fourth direction is joined to the second coupling portion 44 at a fourth joint portion 54. The first duct support portion 46 supports the first central exhaust duct 26 and the second central exhaust duct 28 from the first direction.

The second duct support portion 48 extends in the longitudinal direction in parallel with the first duct support portion 46, and abuts against the first central exhaust duct 26 and the second central exhaust duct 28 from the second direction. The second duct support portion 48 is joined to the first central exhaust duct 26 at a fifth joint portion 56, and is joined to the second central exhaust duct 28 at a sixth joint portion 58. Furthermore, the vicinity of an end portion of the second duct support portion 48 in the third direction is joined to the first coupling portion 42 at a seventh joint portion 60, and the vicinity of an end portion of the second duct support portion 48 in the fourth direction is joined to the second coupling portion 44 at an eighth joint portion 62. The second duct support portion 48 supports the first central exhaust duct 26 and the second central exhaust duct 28 from the second direction. The first joint portion 49, the second joint portion 50, the third joint portion 52, the fourth joint portion 54, the fifth joint portion 56, the sixth joint portion 58, the seventh joint portion 60, and the eighth joint portion 62 may be joint portions formed by welding.

The first duct support portion 46 and the second duct support portion 48 are provided at positions avoiding the first connection ducts 32 and the second connection ducts 34 upward or downward. In a case where the first connection ducts 32 and the second connection ducts 34 are provided in a plurality of tiers, the first duct support portion 46 and the second duct support portion 48 are provided at a position between the vertically-adjacent tiers each containing the first and second connection ducts 32, 34. The first duct support portion 46 and the second duct support portion 48 prevent displacement and vibration of the first central exhaust duct 26 and the second central exhaust duct 28 due to rotation torque.

The cooling device 16 and the fuel cell system 10 of the present embodiment are configured as described above. Hereinafter, the operation of the cooling device 16 will be described.

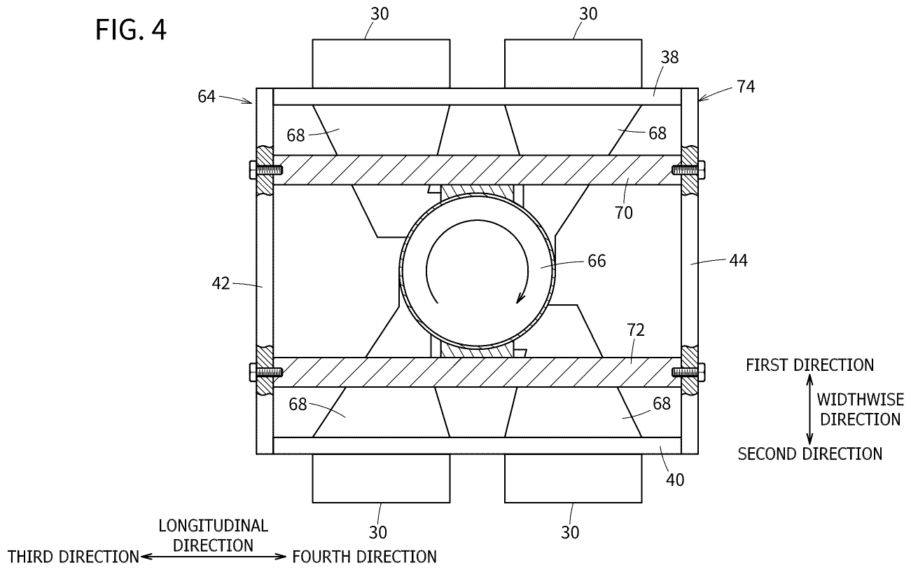

As shown in FIG. 4, a cooling device 64 according to a comparative example discharges the exhaust air of the plurality of radiators 30 through one central exhaust duct 66. A plurality of connection ducts 68 connected to the central exhaust duct 66 are connected so as to generate a rotating flow in the first rotation direction (counterclockwise) in order to prevent a decrease in the exhaust flow rate due to collision of the exhaust air.

In the cooling device 64 of the comparative example, the exhaust air inside the central exhaust duct 66 generates a rotating flow. The central exhaust duct 66 receives a reaction force of the rotating flow of the exhaust air and receives a rotational moment in the second rotation direction, which is opposite to the rotation direction of the exhaust air. As a result, a first duct support portion 70 and a second duct support portion 72 that support the central exhaust duct 66 continue to receive a reaction force accompanied by vibration due to the rotational moment. In order to bear such a reaction force, a frame 74 including the first duct support portion 70 and the second duct support portion 72 is required to have high rigidity, and the frame 74 is increased in size accordingly.

In contrast, as shown in FIG. 3, in the cooling device 16 of the present embodiment, the rotation direction (first rotation direction) of the exhaust air generated in the first central exhaust duct 26 and the rotation direction (second rotation direction) of the exhaust air generated in the second central exhaust duct 28 are opposite to each other. With this configuration, the rotational moment generated by the first central exhaust duct 26 and the rotational moment generated by the second central exhaust duct 28 cancel each other out. As a result, the rotational moment applied to the first duct support portion 46 and the second duct support portion 48 is smaller than that in the comparative example shown in FIG. 4. Therefore, the cooling device 16 of the present embodiment shown in FIG. 3 enables the frame 36 supporting the first central exhaust duct 26 and the second central exhaust duct 28 to be reduced in size.

### Second Embodiment

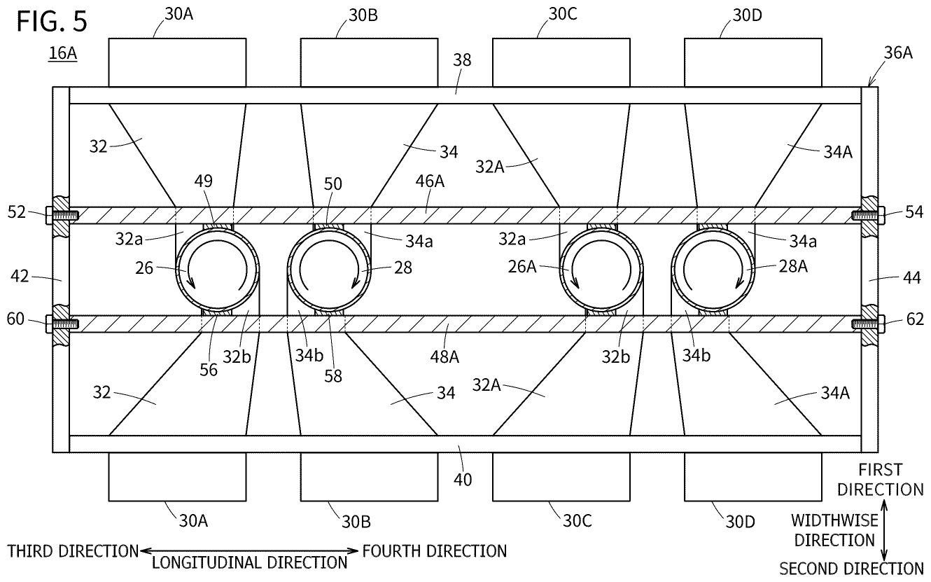

As shown in FIG. 5, a cooling device 16A according to the present embodiment includes a third central exhaust duct 26A and a fourth central exhaust duct 28A in addition to the first central exhaust duct 26 and the second central exhaust duct 28. In the configuration of the cooling device 16A of the present embodiment, the same components as those of the cooling device 16 described with reference to FIGS. 1 to 3 are denoted by the same reference numerals, and the detailed description thereof will be omitted.

As shown in FIG. 5, the first central exhaust duct 26, the second central exhaust duct 28, the third central exhaust duct 26A, and the fourth central exhaust duct 28A are arranged in a line in the longitudinal direction. The third central exhaust duct 26A and the fourth central exhaust duct 28A extend upward. The third central exhaust duct 26A and the fourth central exhaust duct 28A have the same shape and dimensions as the first central exhaust duct 26 and the second central exhaust duct 28.

Third radiators 30C are disposed respectively on a side of the first direction and on a side of the second direction, of the third central exhaust duct 26A. The third radiators 30C are connected to the third central exhaust duct 26A through respective third connection ducts 32A. The third connection duct 32A is formed in the same shape and the same dimensions as the first connection duct 32. The pair of third connection ducts 32A are connected to the third central exhaust duct 26A at positions and in directions that generate a rotating flow of the exhaust air in the first rotation direction.

Fourth radiators 30D are disposed respectively on a side of the first direction and on a side of the second direction, of the fourth central exhaust duct 28A. The fourth radiators 30D are connected to the fourth central exhaust duct 28A through respective fourth connection ducts 34A. The fourth connection duct 34A is formed in the same shape and the same dimensions as the second connection duct 34. The pair of fourth connection ducts 34A are connected to the fourth central exhaust duct 28A at positions and in directions that generate a rotating flow of the exhaust air in the second rotation direction.

A frame 36A of the present embodiment includes a first duct support portion 46A and a second duct support portion 48A. The first duct support portion 46A abuts on the first central exhaust duct 26, the second central exhaust duct 28, the third central exhaust duct 26A, and the fourth central exhaust duct 28A from the first direction to support these ducts. The second duct support portion 48A abuts against the first central exhaust duct 26, the second central exhaust duct 28, the third central exhaust duct 26A, and the fourth central exhaust duct 28A from the second direction to support these ducts.

The cooling device 16A of the present embodiment is configured as described above. In the cooling device 16A of the present embodiment, the rotation directions of the exhaust air are opposite to each other in the first central exhaust duct 26 to the fourth central exhaust duct 28A, which are adjacent to each other. With this configuration, the rotational moments of the first central exhaust duct 26 to the fourth central exhaust duct 28A are canceled out each other. Thus, the cooling device 16A of the present embodiment can reduce the size of the frame 36A including the first duct support portion 46A and the second duct support portion 48A.

The following Supplementary Notes are further disclosed in relation to the above embodiments.

### Supplementary Note 1

The cooling device (16) according to the present disclosure includes: the first central exhaust duct (26); the second central exhaust duct (28) disposed adjacent to and parallel to the first central exhaust duct; the plurality of first radiators (30A) disposed near the first central exhaust duct; the plurality of first connection ducts (32) configured to guide exhaust air from the plurality of first radiators to the first central exhaust duct; the plurality of second radiators (30B) disposed near the second central exhaust duct; the plurality of second connection ducts (34) configured to guide exhaust air from the plurality of second radiators to the second central exhaust duct; and the frame (36) that supports the first central exhaust duct and the second central exhaust duct, wherein the plurality of first connection ducts are connected to the first central exhaust duct in an orientation in which the exhaust air generates a flow in a first rotation direction inside the first central exhaust duct, and the plurality of second connection ducts are connected to the second central exhaust duct in an orientation in which the exhaust air generates a flow in a second rotation direction that is opposite to the first rotation direction, inside the second central exhaust duct.

The cooling device described above can suppress load applied to the frame by canceling the rotational moment generated in the first central exhaust duct with the rotational moment generated in the second central exhaust duct, and thus the frame can be reduced in size.

### Supplementary Note 2

In the cooling device according to Supplementary Note 1, the first radiators may be disposed one on each of the first direction side and the second direction side of the first central exhaust duct, the first direction being orthogonal to a central axis of the first central exhaust duct, the second direction being opposite to the first direction, and the second radiators may be disposed one on each of the first direction side and the second direction side of the second central exhaust duct. The cooling device can efficiently discharge exhaust air from the plurality of radiators with a compact device configuration.

### Supplementary Note 3

In the cooling device according to Supplementary Note 2, one of the first connection ducts that extends from the first radiator disposed on the side of the first direction is connected to the first central exhaust duct at a position shifted, in the third direction orthogonal to the first direction, from another one of the first connection ducts that extends from the first radiator disposed on the side of the second direction, and one of the second connection ducts that extends from the second radiator disposed on the side of the first direction is connected to the second central exhaust duct at a position shifted, in the fourth direction opposite to the third direction, from another one of the second connection ducts that extends from the second radiator disposed on the side of the second direction. In this cooling device, the rotation direction of the exhaust air in the first central exhaust duct and the rotation direction of the exhaust air in the second central exhaust duct can be set to be opposite to each other.

### Supplementary Note 4

In the cooling device according to Supplementary Note 3, the second central exhaust duct may be disposed on a side of the fourth direction of the first central exhaust duct.

### Supplementary Note 5

In the cooling device according to Supplementary Note 4, the frame may include: the first duct support portion (46) that abuts against the first central exhaust duct and the second central exhaust duct from the first direction and supports the first central exhaust duct and the second central exhaust duct; and the second duct support portion (48) that abuts against the first central exhaust duct and the second central exhaust duct from the second direction and supports the first central exhaust duct and the second central exhaust duct. In this cooling device, the frame including the first duct support portion and the second duct support portion can be reduced in size.

### Supplementary Note 6

In the cooling device according to Supplementary Note 2, the first radiators, the first connection ducts, the second radiators, and the second connection ducts may be stacked in a plurality of tiers in a direction of the central axis. This cooling device can efficiently discharge the exhaust air from a large number of radiators with a compact device configuration.

### Supplementary Note 7

In the cooling device according to Supplementary Note 2, the central axis may be directed in the vertical direction, and each of the first central exhaust duct and the second central exhaust duct may include an outlet on the upper side of the vertical direction. This cooling device can curb the influence of the exhaust air on the adjacent containers, and thus can be convenient for mounting the cooling device on the container.

### Supplementary Note 8

In the cooling device according to Supplementary Note 7, the radiators disposed on the first direction side may take in the outside air from the first direction, and the radiators disposed on the second direction side may take in the outside air from the second direction. When a plurality of similar containers are arranged, the present cooling device can take in the outside air from a direction in which the outside air is hardly affected by the exhaust air, and thus it is convenient for densely arranging the containers.

### Supplementary Note 9

The fuel cell system (10) of the present disclosure includes the cooling device according to any one of Supplementary Notes 1 to 8, and the plurality of fuel cells (22), wherein the number of the fuel cells is the same as the total number of the first radiators and the second radiators, and the plurality of fuel cells are connected in parallel to the cooling device. The fuel cell system can be manufactured at low cost since the fuel cells and the radiators for vehicles, which are mass-produced in large quantities, can be diverted.

Although the present disclosure has been described in detail, the present disclosure is not limited to the above-described embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. Further, the embodiments can also be implemented together in combination. For example, in the above-described embodiments, the order of operations and the order of processes are shown as examples, and the present invention is not limited to them. The same applies to the case where numerical values or mathematical expressions are used in the description of the above-described embodiments.

1. A cooling device comprising:
a first central exhaust duct;
a second central exhaust duct disposed adjacent to and parallel to the first central exhaust duct;
a plurality of first radiators disposed near the first central exhaust duct;
a plurality of first connection ducts configured to guide exhaust air from the plurality of first radiators to the first central exhaust duct;
a plurality of second radiators disposed near the second central exhaust duct;
a plurality of second connection ducts configured to guide exhaust air from the plurality of second radiators to the second central exhaust duct; and
a frame that supports the first central exhaust duct and the second central exhaust duct,
wherein the plurality of first connection ducts are connected to the first central exhaust duct in an orientation in which the exhaust air generates a flow in a first rotation direction inside the first central exhaust duct, and
the plurality of second connection ducts are connected to the second central exhaust duct in an orientation in which the exhaust air generates a flow in a second rotation direction that is opposite to the first rotation direction, inside the second central exhaust duct.

2. The cooling device according to claim 1, wherein
the first radiators are disposed one on each of a side of a first direction and a side of a second direction, of the first central exhaust duct, the first direction being orthogonal to a central axis of the first central exhaust duct, the second direction being opposite to the first direction, and
the second radiators are disposed one on each of a side of the first direction and a side of the second direction, of the second central exhaust duct.

3. The cooling device according to claim 2, wherein
one of the first connection ducts that extends from the first radiator disposed on the side of the first direction is connected to the first central exhaust duct at a position shifted, in a third direction orthogonal to the first direction, from another one of the first connection ducts that extends from the first radiator disposed on the side of the second direction, and
one of the second connection ducts that extends from the second radiator disposed on the side of the first direction is connected to the second central exhaust duct at a position shifted, in a fourth direction opposite to the third direction, from another one of the second connection ducts that extends from the second radiator disposed on the side of the second direction.

4. The cooling device according to claim 3, wherein
the second central exhaust duct is disposed on a side of the fourth direction, of the first central exhaust duct.

5. The cooling device according to claim 4, wherein
the frame includes:
a first duct support portion that abuts against the first central exhaust duct and the second central exhaust duct from the first direction and supports the first central exhaust duct and the second central exhaust duct; and
a second duct support portion that abuts against the first central exhaust duct and the second central exhaust duct from the second direction and supports the first central exhaust duct and the second central exhaust duct.

6. The cooling device according to claim 2, wherein
the first radiators, the first connection ducts, the second radiators, and the second connection ducts are stacked in a plurality of tiers in a direction of the central axis.

7. The cooling device according to claim 2, wherein
the central axis is directed in a vertical direction, and each of the first central exhaust duct and the second central exhaust duct includes an outlet on an upper side of the vertical direction.

8. The cooling device according to claim 7, wherein the radiators disposed on the side of the first direction take in outside air from the first direction, and the radiators disposed on the side of the second direction take in outside air from the second direction.

9. A fuel cell system comprising the cooling device according to claim 1 and a plurality of fuel cells,
wherein a number of the fuel cells is same as a total number of the first radiators and the second radiators, and
the plurality of fuel cells are connected in parallel to the cooling device.
